(19) United States
(12) Patent Application Publication
(10) Pub. No.: US 2009/0199594 A1
(43) Pub. Date: Aug. 13, 2009

(54) CLOSED LOOP CONTROL SYSTEM FOR THE HEAT-TREATMENT OF GLASS

(75) Inventors: Mark Abbott, Dundas, MN (US); Eric Hegstrom, Tucson, AZ (US)

Correspondence Address: EDWARD WECK, 6608 MINNETONKA BLVD., ST. LOUIS PARK, MN, 55426, US

(73) Assignee: LITESENTRY CORPORATION, Dundas, MN (US)

(21) Appl. No.: 12/367,674

(22) Filed: Feb. 9, 2009

Related U.S. Application Data
(60) Provisional application No. 61/027,484, filed on Feb. 10, 2008.

(51) Int. Cl. C03B 27/00; C03B 35/14; C03B 27/04

(52) U.S. Cl. 65/29.14; 65/162; 65/163; 65/161; 65/29.12

(57) ABSTRACT

A method and apparatus for controlling the process used in the heat treatment of glass measures the quality of the glass following the heat treatment process. Inputs to the control system for the heat treatment process derive from the automated inspection of glass following heat treatment. Outputs from the control system for the heat treatment process may adjust one or more parameters in the heat treatment process including a furnace or heating setting, a transport setting, and a quench or cooling setting.

### BENEFIT OF PRIORITY

This application claims the benefit of priority of prior filed U.S. Application Ser. No. 61/027,484 filed Feb. 10, 2008, which is herein incorporated by reference in its entirety.

### BACKGROUND OF THE INVENTION

1. Summary of the Invention

The present invention relates to a method and apparatus for controlling the process used in the heat treatment of glass by measuring the quality of the glass following the heat treatment process. Inputs to the control system for the heat treatment process derive from the automated inspection of glass following heat treatment. Outputs from the control system for the heat treatment process may adjust one or more parameters in the heat treatment process including a furnace or heating setting, a transport setting, and a quench or cooling setting.

2. Description of the Related Art

Commercial glass is heat treated for the purpose of increasing internal stress resulting in increased strength and, when stress is increased to sufficient levels, resulting in safe breakage into small particles when the glass is broken. During the heat treatment of transparent materials, a glass sheet is transported on a glass transport, is heated in a furnace and is cooled rapidly in a quenching station. Recent advances in glass processing technologies allow for the continuous inspection of the glass as it exits the heat treatment process. The glass may be inspected for a variety of properties, including (1) optical distortion, (2) physical deformation including overall bow and local bow which are means of measuring variance from the desired flatness or curvature of the glass, (3) surface defects such as scratches and blemishes, (4) included defects such as seeds or stones, (5) geometric defects such as size or shape, and (6) geometric defects such as holes or drilled features, (7) the presence of appropriate coatings such as low emissivity coatings, and (8) appropriate glass thickness. Specifications govern production criteria for all of these properties. Non-conformances or “defects” are imparted to the glass during one or more manufacturing processes. Some of these defects are imparted to the glass during the heat treatment process, in particular optical distortion, physical deformation and some surface defects.

Minimization of the defects to the glass sheets is an objective of glass manufacturers. The heat treatment of glass is a dynamic process involving numerous variables relating to heating, cooling, transport and the glass sheet. Heating variables include heat sources and distribution geometry including radiant heating elements, convective heating sources such as air heated and circulated within the furnace and conductive heating from rollers. Heat sources are typically arrayed within the furnace in logical methods to distribute the heat and to allow control of the heat to adjust to variance of heat demand within the furnace. Transport variables include the conveyance velocity. Cooling variables include cooling or quenching, including air temperature, airflow, and air distribution. Cooling variables also include outside air used in the quench process including temperature and relative humidity. Glass sheet variables include the glass substrate to be heat-treated, its geometry, thickness and location on the conveyor as it travels through the heat treatment process.

In order to achieve and maintain superior quality glass, the manufacturing process includes measurements of individual glass samples from the total number of sheets produced and subsequent manual adjustments to the heat treatment process parameters to correct problems and maintain satisfactory quality. Samples are typically measured at the outlet of the heat treatment process at a rate of one per hour or less frequently. Manual inspection is done by human and hand tools. The low frequency of sampling and slow rate of inspection may result in large quantities of glass produced between samples and before adjustments are made to the process parameters. This can result in large quantities of glass produced to inferior quality levels.

Recent advances in automated inspection systems have resulted in the wide implementation of cost effective automated inspection systems in the glass manufacturing facility. Automated inspection systems are capable of measuring and quantifying features such as (1) optical distortion, (2) physical deformation including overall bow and local bow which are means of measuring variance from the desired flatness or curvature of the glass, (3) surface defects such as scratches and blemishes, (4) included defects such as seeds or stones, (5) geometric defects such as size or shape, and (6) geometric defects such as holes or drilled features, (7) the presence of coatings such as low emissivity coatings, and (8) glass thickness. Outputs from the automated inspection systems are termed inspection parameters and can be communicated electronically to the heat treatment process control system in real time. Using the inspection parameters as inputs, the heat treatment control system can be adjusted automatically and immediately based on logic algorithms.

A need exists for automated adjustment to the parameters controlling heat treatment processes based on feedback from automated inspection systems monitoring the glass as it exits the heat treatment process. Such a system would provide real-time correction to process parameters resulting in significant cost savings by rapidly correcting the process parameters causing inferior quality glass. The heat treatment system may have many glass sheets within the process zones. Slow inspection by humans and slow adjustments by humans to process parameters result in large numbers of defective sheets. Automated and instantaneous inspections of glass sheets immediately after the heat treatment process linked to real-time corrections to process parameters shortens the time for correction to a problematic parameter and therefore significantly decreases the number of defective glass sheets produced.

A need exists for automating the adjustment of the parameters controlling the heat treatment process in order to remove the human from the adjustment process. The complexity of the outputs from the quality inspection and of the inputs to the heat treatment process control exceeds the capacity of the typical human machine operator. The personnel hired to operate the heat treatment process often lack training in complex technical fields. Humans are not generally capable of making rapid decisions to adjust multiple complex parameters based on multiple inputs.

### SUMMARY OF THE INVENTION

Apparatus and methods in accordance with the present inventions may resolve many of the needs and shortcomings discussed above and will provide additional improvements and advantages as will be recognized by those skilled in the art upon review of the present disclosure.

Inspection of glass sheets that have passed through a glass heat treatment production process may indicate a number of defects. The defects in the glass sheets may be a direct result of specific settings on the glass transport, the furnace, and the quenching stations. An inspection station located downstream from the heat treatment process (including glass transport, the heating in a furnace and quenching) measures inspection parameters of glass sheets passing through the inspection station. The heat treatment of tempering process may be adjusted with the input derived from the results obtained from inspection of glass sheets passing the inspection station. Inspection parameters that may be inputs for the closed loop control of a heat treatment process include lens power of the a glass sheet, a depth profile of a glass sheet, an end profile of a glass sheet, a side profile of a glass sheet, or a two-dimensional profile of a glass sheet.

Specific inspection parameter outputs from the inspection system may include but are not limited to; (1) optical distortion in millidiopters (mD) over the entire glass sheet, (2) minimum and maximum values of mD over the glass sheet; (3) standard deviation of mD over the glass sheet; (4) optical distortion (mD) over specific regions of the glass sheet such as the leading edge, the trailing edge, the perimeter, the central area, or any other area which can be described in a plane; (5) physical deformation of the glass including bow in either X or Y, roll wave or repetitive, sinusoidal waves in the glass sheet, edge kink, edge curl, belly banding, pocket or hammer distortion, and other types of deformation or departures from planarity; (6) the presence of coatings such as low emissivity coatings; and (7) glass thickness. Further, statistics may be derived from the above inspection parameters including average, mean, 1, 2, 3 or more standard deviations from a norm, histograms and distributions of data, and trends of said data over time. Further, area statistics may be derived to judge particular areas of the glass sheets relative to other areas of the glass sheets. Multiple quality thresholds for any of the inspection parameters may be used to judge the quality of the glass sheets and report departure from the target quality, even if the quality of the glass sheet does not represent a “failure”. In this manner inspection parameters of a wide range and variety may be sent to the heat treatment control system, providing information from which to make changes to the transport settings, furnace settings or quench settings.

The inputs for the closed loop control of a tempering furnace may be used to adjust the line velocity of transport of a glass sheet, furnace parameters including heat profiles, or quench parameters. The line velocity of transport may be increased or decreased. Increased levels of optical distortion or physical deformation can be mitigated by increasing line velocity and therefore decreasing the time the glass sheet is in the heating area of the furnace. Inversely, very low levels of optical distortion or physical deformation may indicate insufficient heating of the glass sheets and therefore the line velocity may be decreased to correct the condition.

The inspection system for optical distortion and physical deformation identifies areas of the glass sheets which exhibit excessive optical distortion or physical deformation. For example, leading or trailing edges of individual glass sheets may exhibit excessive distortion, also called edge kink. Furnace and quench settings could be adjusted to mitigate this excessive distortion or edge kink. For example, furnace settings could adjust the height of the last roller in the furnace prior to exiting to the quench or adjusting the height of the first roller in the quench immediately following the furnace. Additional examples include furnace settings adjustments to localization of heat sources focusable on one or more areas of the furnace. Additional examples include furnace settings adjustments to one or multiple heat sources in specific profiles as shown in FIG. 4, including lateral, longitudinal and a combination of lateral and longitudinal heat sources. The time and magnitude of the focus of said heat sources could be controlled according to the inspection parameter inputs. Additional examples include furnace settings adjustments to the temperature of the last roller in the furnace or the first roller in the quench. Additional examples include quench settings adjustments to the air flow profile. Additional examples include furnace settings adjustments involving heating and cooling areas of the furnace including heating above or below the glass while cooling below or above the glass. Additional examples include furnace settings adjustments to lower and upper heating zones comprised of differing types of heat sources and differing types of geometries. Additional examples include furnace settings adjustments according to the coatings applied to and the thickness of the glass sheets.

Excessive distortion may be exhibited on a first glass sheet while a laterally adjacent second glass sheet may exhibit low levels of distortion. In such a case furnace settings for heat sources in particular areas of the furnace may be adjusted to equalize the heating and produce more uniform results. The heat input to the furnace may be increased or decreased in total, selectively in areas of the furnace, or selectively in patterns throughout the furnace.

Excessive distortion may be exhibited on a first glass sheet while a longitudinally adjacent second glass sheet may exhibit low levels of distortion. In such a case furnace settings for heat sources in particular areas of the furnace may be adjusted to equalize the heating and produce more uniform results. Alternatively, total heat input may be adjusted or line velocity adjusted to correct for nonuniformity in the resulting quality of the glass sheets.

Similarly, when the inspection system for optical distortion and physical deformation identifies excessive distortion in particular areas of the glass or identifies excessive bow over the entire length or width of the glass sheet, adjustments may be made to the furnace and/or quench parameters. Quench parameters that may be adjusted include the distance of the quench air nozzles from the glass, the blower speed, the mass flow of quenching air, and the profile or selective distribution of the quenching air. If the end profile of the glass sheet or the side profile of the glass sheet indicates that the glass sheet is bowed, the furnace parameters or the quench parameters can be adjusted, changing the furnace or quench conditions thereby reducing the amount of bow measured in the glass sheet at the inspection station. If the glass demonstrates particular types of distortion such as edge kink or roller wave, the quench parameters can be adjusted to mitigate excessive distortion of particular types.

The following U.S. patents address novel approaches to selective heating of glass in a heat treatment system. Each of the methods described in the following U.S. patents could be used with inspection parameter inputs from the herein described invention to successfully implement this glass heat treatment real-time automated process control system. U.S. Pat. No. 6,064,040 describes a method of localization of heating focusable on at least one zone laterally or longitudinally. Time of the focused heat and magnitude of the focused heat are controlled. These furnace settings could be adjusted according to inputs from the inspection parameters as described herein to correct poor quality and improve the overall quality of the glass sheet produced. U.S. Pat. No. 6,131,412 describes a method of adjusting temperature in the furnace and controlling a dwell time of the glass sheet within the furnace. These furnace settings could be adjusted according to inputs from the inspection parameters as described herein to correct poor quality and improve the overall quality of the glass sheet produced. U.S. Pat. No. 6,282,923 describes a method of variably heating and cooling the upper and lower areas of the furnace. These furnace settings could be adjusted according to inputs from the inspection parameters as described herein to correct poor quality and improve the overall quality of the glass sheet produced. U.S. Pat. No. 7,216,511 describe a furnace having upper and lower zones with a furnace incorporating different heating methods and adapted for tempering glass panels with low emissivity coatings applied. These furnace settings could be adjusted according to inputs from the inspection parameters as described herein to correct poor quality and improve the overall quality of the glass sheet produced.

The following U.S. patents address novel approaches to quenching the glass sheets in a heat treatment system. Each of the methods described in the following U.S. patents could be used with inspection parameter inputs from the herein described invention to successfully implement this glass heat treatment real-time automated process control system. U.S. Pat. No. 6,279,350 describes a method for adjusting the cooling air in the quench utilizing a series of valves of dampers. These quench settings could be adjusted according to inputs from the inspection parameters as described herein to correct poor quality and improve the overall quality of the glass sheet produced. U.S. Pat. No. 4,886,548 describes a blow back device for quenching the glass sheet. These quench settings could be adjusted according to inputs from the inspection parameters as described herein to correct poor quality and improve the overall quality of the glass sheet produced. U.S. Pat. No. 6,513,348 describes a method utilizing two or more quench zones and upper and lower quench air controls to improve throughput of the glass heat treatment system. These quench settings could be adjusted according to inputs from the inspection parameters as described herein to correct poor quality and improve the overall quality of the glass sheet produced.

The following U.S. patents address novel approaches to conveying and forming glass sheets in a heat treatment system. Each of the methods described in the following U.S. patents could be used with inspection parameter inputs from the herein described invention to successfully implement this glass heat treatment real-time automated process control system. U.S. Pat. No. 6,378,339 describes a method of roll forming glass sheets that prevents glass edge curling. These conveyor settings could be adjusted according to inputs from the inspection parameters as described herein to correct poor quality and improve the overall quality of the glass sheet produced. U.S. Pat. No. 7,287,401 describes a heat treatment system for forming glass sheets into cylindrical shapes. The conveyor settings, furnace settings and quench settings described could be adjusted according to inputs from the inspection parameters as described herein to correct poor quality and improve the overall quality of the glass sheet produced.

All patents cited herein are hereby incorporated by reference in their entirety to the same extent as if each individual patent was specifically and individually indicated to be incorporated by reference.

Improved control of the heat treatment process leads to decreased scrap of defective product, decreased labor requirements to control the process, increased ability to meet established quality levels, decreased use of energy and raw material inputs due to improved yield and therefore decreased cost of production.

Advantages offered by the present invention include:
1) Minimization of the human input to control of a complex process,
2) Repeatable and consistent adjustment of the heat treatment control system providing repeatable and consistent product quality,
3) Decrease in labor, energy and material costs due to increased yield and decreased scrap from the process.

Other features and advantages of the invention will become apparent from the following detailed description, and from the claims.

### BRIEF DESCRIPTION OF THE DRAWINGS

All Figures are illustrated for ease of explanation of the basic teachings of the present invention only; the extensions of the Figures with respect to number, position, relationship and dimensions of the sheets to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

FIG. 1 of the drawings shows a flow chart of a glass heat treatment real-time automated process control system.

FIG. 2 of the drawings shows a graph of maximum and minimum values of the departure from flatness of a glass sheet.

FIG. 3A of the drawings shows a side view of a glass sheet following inspection at an inspection station.

FIG. 3B of the drawings shows an end view of a glass sheet following inspection at an inspection station.

FIGS. 4A-D show schematic diagrams of glass tempering furnaces.

FIG. 5A shows an elevated side view of a glass sheet following inspection at an inspection station.

FIG. 5B shows an elevated end view of a glass sheet following inspection at an inspection station.

### DETAILED DESCRIPTION OF THE INVENTION

The figures generally illustrate exemplary embodiments of a glass heat treatment real-time automated process control system 10 or components thereof, which include aspects of the present inventions. The particular embodiments of the control system 10 illustrated in the figures have been chosen for ease of explanation and understanding of various aspects of the present inventions. These illustrated embodiments are not meant to limit the scope of coverage but instead to assist in understanding the context of the language used in this specification and the appended claims.

The present invention provides a glass heat treatment real-time automated process control system 10 and methods for implementing the control system 10. A glass sheet 12 is transported by the glass transport 101. The glass transport 101 moves the glass sheet downstream through a furnace 105, a quenching station 109 and past an inspection station 113 and to an unloading station 117. The quenching station 109 directs air toward the glass sheet 12 and affects the air temperature, airflow and distribution of air directed toward the glass sheet 12. The control system 10 measures inspection parameters 120 at the inspection station 113 and converts the inspection parameters 120 into control parameters for the heat treatment process 122. The control parameters for the heat treatment process 122 include a transport setting 124 for the glass transport 101, a furnace setting 126 for heating in the furnace 105 and a quench setting 128 for the quenching 109.

The inspection parameters 120 may be used to adjust any or all of the transport setting 124 for the glass transport 101, a furnace setting 126 for heating in the furnace 105 and a quench setting 128 for the quenching 109. The transport setting 124 may be adjusted continuously between 1 mm/sec and 2,000 mm/sec. The furnace setting 126 may adjust a heat input into an area of the furnace 105, into the total furnace 105, in multiple areas of the furnace 105 or in patterns in the furnace 105. The quench setting 128 affects air temperature, airflow, and air distribution. The inspection parameter 120 may be local or overall distortion of a glass sheet as measured in lens power, or depth profile of a glass sheet, an end profile of a glass sheet, a side profile of a glass sheet, or a two-dimensional profile of a glass sheet, or a three-dimensional profile of a glass sheet. Distortion and physical deformation inspection parameters may be analyzed using statistics to establish trends in the inspection results.

The method for glass heat treatment real-time automated process control 10 includes transporting 103 a glass sheet 12 with a glass transport 101. The glass transport 101 has a transport setting 124. The glass sheet 12 is heated 107 in the furnace 105. The furnace 105 has a furnace setting 126. The glass sheet 12 is quenched 111 at the quenching station 109. The quenching station 109 has a quench setting 128. The glass transport 101 transports the glass sheet through the furnace 105 and the quenching station 109 and past the inspection station 113 and to the unloading station 117. The method includes measuring an inspection parameter 120 of the glass sheet 12 at an inspection station 113, with the inspection station 113 downstream along the glass transport 101 from the quenching station 109.

The method also includes adjusting at least one of the furnace setting 126, the quench setting 128 and the transport setting 124. Adjusting the transport setting 124 may be continuously variable between 1 mm/sec and 2,000 mm/sec. Adjusting the furnace setting 126 may include adjusting a heat input into an area of the furnace, adjusting a heat input into the total furnace, adjusting a heat input in multiple areas of the furnace or adjusting a heat input in a pattern in the furnace. Adjusting the quench setting 128 may be adjusting air temperature, airflow, or air distribution. Measuring the inspection parameter 120 may be measuring a depth profile of a glass sheet, measuring an end profile of a glass sheet, measuring a side profile of a glass sheet, or measuring a two-dimensional profile of a glass sheet.

### Specific Embodiments

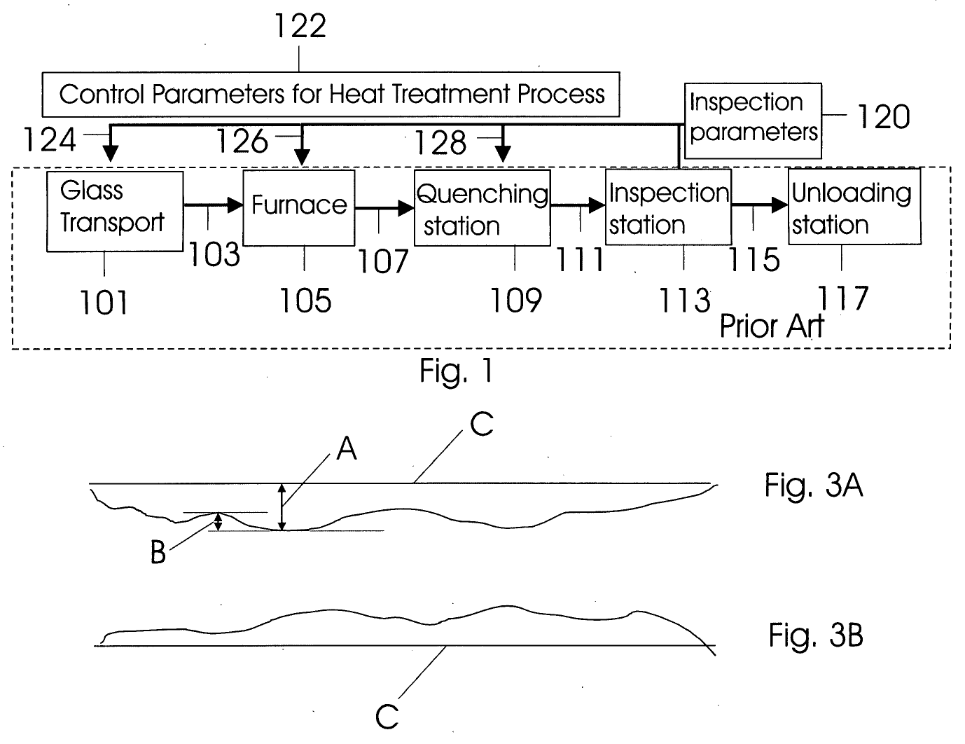

FIG. 1 illustrates the control system 10 of the present invention. A glass transport 101 transports a glass sheet 12 into a furnace 105. The furnace 105 heats the glass sheet 107. The glass transport 101 transports the glass sheet 12 into the quenching station 109. The glass sheet 12 is quenched 111 at the quenching station 109. The glass transport 101 transports the glass sheet 12 past the inspection station 113. Inspection parameters 120 are measured at the inspection station 113. Inspection parameters 120 are used to determine control parameters for the heat treatment process 122. The control parameters for the heat treatment process 122 include a transport setting 124 for glass transport 101, a furnace setting 126 for heating in the furnace 105 and a quench setting 128 for quenching at the quenching station 109. Any or all of the transport setting 124 for glass transport 101, the furnace setting 126 for heating in the furnace 105 and the quench setting 128 for quenching at the quenching station 109 may be altered depending on the inspection parameters 120. The inspection system is preferably the OSPREY™, a Distortion Measurement System for Glass, from LiteSentry Corporation (Dundas, Minn.).

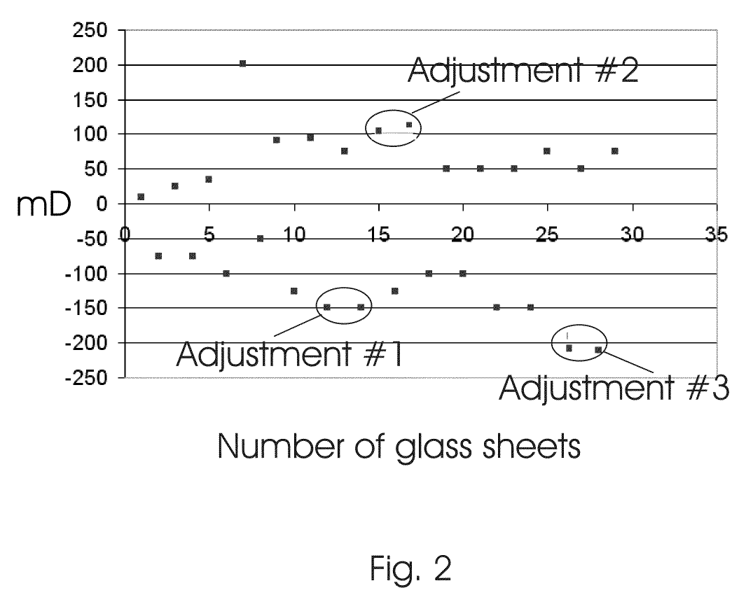

FIG. 2 illustrates the distortion for glass sheets 12 as measured at the inspection station 113. As shown in FIG. 2, the distortion is measured in millidiopters (MD) as lens power over the entire glass sheet 12. Measurements are 24 mm in diameter and are made across the length and width of a glass sheet 12. Zero (0) mD represents a perfectly flat lens or glass sheet 12. As the measurements of distortion of a glass sheet 12 increase, the glass sheet 12 is more distorted. Distortion greater than about ±200 mD departs sufficiently from flatness and is considered defective for many applications. Distortion greater than or equal to about ±200 mD warrants immediate adjustment to the heat treatment process (FIG. 2, Adjustment #3). Distortion greater than about ±100 mD but less than about ±200 mD is considered acceptable for many applications, but is of sufficient distortion to warrant adjustment to the heat treatment process (FIG. 2, Adjustment #1 and Adjustment #2). Any value of distortion may be used to drive an algorithm to adjust the heat treatment control system 10. An algorithm is defined as an equation which compares the initial value of an inspection parameter 120 to a later value of the inspection parameter 120 and adjusts a transport setting 124, a furnace setting 126 or a quench setting 128 in the heat treatment system 10 according to the change recorded in the inspection parameter 120. An algorithm may evaluate multiple inspection parameters 120 and change multiple settings (transport setting 124, a furnace setting 126 or a quench setting 128) to achieve the desired improvements in process control and resulting quality of the glass sheets 12.

As distortion rises above established levels such as about ±200 mD, the transport setting 124 would be incrementally increased in velocity to move the glass sheet faster through the furnace and therefore spend less time in the furnace and thereby impart less heat into a glass sheet 12. Inversely, as distortion drops to below established levels such as about ±50 mD, the transport setting 124 would be incrementally decreased in velocity to impart more heat into a glass sheet 12. Alternative furnace settings 126 could be adjusted to increase or decrease the heat imparted to the glass sheet. However, adjustments to the heat sources will not result in rapid changes to the quality results due to the high thermal mass of the system resulting in delayed response time between the 30 adjustment and the resulting change in heat flow.

FIG. 3A illustrates a side view of a glass sheet 12 obtained at the inspection station 113. As seen in FIG. 3A, there can be local minima and maxima, e.g. B, in the deviations from flatness C. These local minima and maxima B are termed “local bow” (European terminology) or “peak-to-valley” (North American terminology) and are the cause for rejection of a glass sheet 12 as not flat. The long-range curve is termed overall bow A and is also cause for rejection of a glass sheet 12 as not flat. FIG. 3A illustrates concave bow or glass “holding water”. FIG. 3B illustrates a side view of a glass sheet 12 obtained in the inspection process exhibiting convex bow or “shedding water. The type of local bow B and overall bow A will represent outputs of different inspection parameters 120 and will result in different control parameters for the heat treatment process 122. For example, adjustments to the quench setting 128 may involve increasing the mass flow of quench air to correct concave bow while decreasing the mass flow of quench air to correct convex bow.

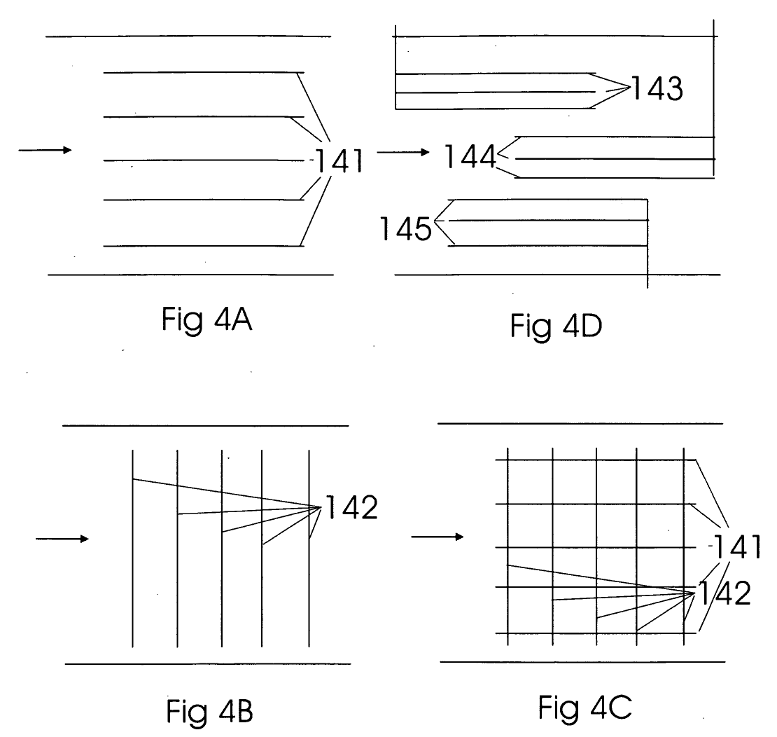

FIG. 4 illustrates various distribution methods of heat in a furnace 105. Heat treatment systems for glass currently are manufactured by many companies and exhibit many designs. Inherent to many of the newer furnace designs are variable controls for the heat sources. The heat sources are typically resistive elements providing radiant heat or piping with nozzles providing convective heat. The source of convective heat may be a chamber in which the air is heated by radiant sources or by gas burners or by other sources of heat.

The heat may be applied to the glass sheets from above and/or below and from various arrays of heat sources. In FIGS. 4A-4D, the arrow represents the direction of transporting the glass sheet 103. Heating sources include longitudinal heat sources 141 (parallel to the direction of glass travel, FIG. 4A), lateral heats sources 142 (perpendicular to the direction of glass travel, FIG. 4B), both longitudinal heat sources 141 and lateral heat sources 142 (FIG. 4C) or any combination of longitudinal heat sources 141 and lateral heat sources 142. Some furnaces have separate banks of heat sources 143, 144, 145 which may be controlled independently as shown in FIG. 4D

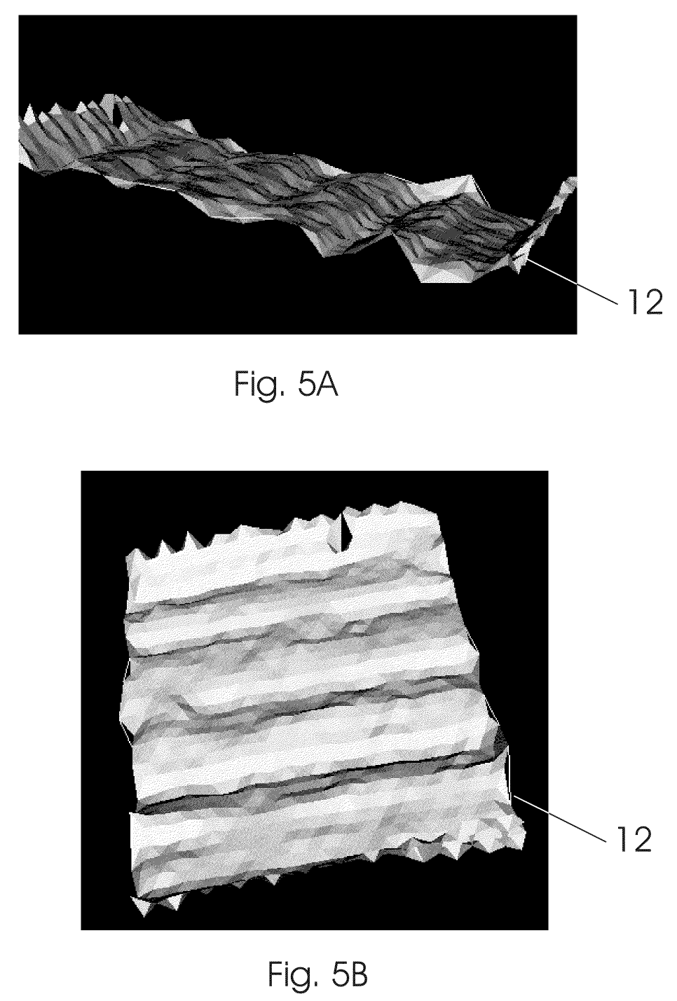

FIG. 5A illustrates a 3-dimensional depiction of the elevated side view of a glass sheet 12 showing a depth profile of a glass sheet 12, an end profile of a glass sheet 12, a side profile of a glass sheet 12, and a two-dimensional profile of a glass sheet 12.

FIG. 5B illustrates a 3-dimensional depiction of the elevated end view of the same glass sheet 12 shown in FIG. 5A showing a depth profile of a glass sheet 12, an end profile of a glass sheet 12, a side profile of a glass sheet 12, and a two-dimensional profile of a glass sheet 12. These are typical outputs from the OSPREY™, a distortion measurement inspection system, and represent the inspection parameters 120 available for output as control parameters for heat treatment process 122. The OSPREY™ has been described in patent application Ser. No. 10/377,089 for “OPTICAL SYSTEM FOR IMAGING DISTORTIONS IN MOVING REFLECTIVE SHEETS”, filed Feb. 28, 2003.

In operation, at the inspection station 113, a user would establish quality criteria including levels of optical distortion and physical deformation, which are acceptable or unacceptable to the customer. Further, the user may establish levels of quality that are acceptable to the customer but warrant incremental adjustment to the furnace 105 and quenching station 109 in order to maintain optimal control of the glass heat treatment real-time automated process control system 10. Inspection parameters 120 are chosen to be output from the inspection system 113 and sent to the heat treatment process control system 10. The inspection parameters 120 from the inspection station 113 would be determined through experimentation to be most sensitive to changing the variables causing inferior quality, i.e. a sensitivity analysis of the heat treatment process. An algorithm compares the current values of the inspection parameters 120 to the initial values of the inspection parameters and automatically adjusts the control parameters for the heat treatment process 122 including the transport setting 124, the furnace setting 126 and the quench setting 128.

The glass heat treatment real-time automated process control system 10 receives an inspection parameter 120 for every glass sheet 12 processed. The algorithm implementing automatic adjustments to control parameters for the heat treatment process 122 may react to a single glass sheet 12 showing changes in inspected quality, or the algorithm may collect series of data establishing trends in the inspection parameters 120 and react to trends exhibiting repetitive degradation in inspected quality. Trend analysis is important to compensate for hysteresis in the heat treatment system.

The foregoing discussion discloses and describes merely exemplary embodiments of the present invention. Upon review of the specification, one skilled in the art will readily recognize from such discussion, and from the accompanying drawings and claims, that various changes, modifications and variations can be made therein without departing from the spirit and scope of the invention as defined in the following claims.

What is claimed is:

1. A glass heat treatment real-time automated process control system comprising:
a glass transport having a transport setting;
a furnace having a furnace setting;
a quenching station having a quench setting, with the quenching station downstream from the furnace, with the glass transport transporting a glass sheet through the furnace, and with the glass transport transporting the glass sheet through the quenching station; and
an inspection station measuring an inspection parameter of the glass sheet, with the inspection station downstream from the quenching station, with the inspection parameter adjusting at least one of the furnace setting, the quench setting and the transport setting.

2. The glass heat treatment real-time automated control system according to claim 1 wherein the inspection parameter has an initial value, and when the inspection parameter deviates from the initial value the transport setting is adjusted, with the transport setting continuously variable between 1 mm/sec and 2,000 mm/sec.

3. The glass heat treatment real-time automated control system according to claim 1 wherein the furnace has a heat input, an area, a total area, multiple areas and a localized pattern, the inspection parameter has an initial value, and when the inspection parameter deviates from the initial value, the furnace setting adjusts the heat input into the area of the furnace, adjusts the heat input into the total area of the furnace, adjusts the heat input into the multiple areas of the furnace or adjusts the heat input in the localized pattern in the furnace.

4. The glass heat treatment real-time automated control system according to claim 1 wherein the quenching station directs air toward the glass sheet, with the quenching station affecting flow or distribution of the air toward the glass sheet, with the inspection parameter having an initial value, and when the inspection parameter deviates from the initial value, the quench setting adjusts the flow or the distribution of the air directed toward the glass sheet.

5. The glass heat treatment real-time automated control system according to claim 1 wherein the inspection parameter is a depth profile of a glass sheet, an end profile of a glass sheet, a side profile of a glass sheet, a two-dimensional profile of a glass sheet, or a three-dimensional profile of a glass sheet.

6. The glass heat treatment real-time automated control system according to claim 1 wherein the inspection parameter is a measure of lens power, with the inspection parameter defining a maximum lens power, a minimum lens power and/or a statistical value of lens power.

11. A method for glass heat treatment real-time automated process control comprising:
transporting a glass sheet with a glass transport, with the glass transport having a transport setting;
heating the glass sheet in a furnace, with the furnace having a furnace setting;
quenching the glass sheet at a quenching station, with the quenching station having a quench setting, with the quenching station downstream from the furnace, with the glass transport transporting a glass sheet through the furnace, and with the glass transport transporting the glass sheet through the quenching station;
measuring an inspection parameter of the glass sheet at an inspection station, with the inspection station downstream from the quenching station; and
adjusting at least one of the furnace setting, the quench setting and the transport setting.

12. The method according to claim 11 wherein the inspection parameter has an initial value and adjusting the transport setting is done when the inspection parameter deviates from the initial value with the transport setting continuously variable between 1 mm/sec and 2,000 mm/sec.

13. The method according to claim 11 wherein the inspection parameter has an initial value and the furnace has a heat input, an area, a total area, multiple areas and a localized pattern, adjusting the furnace setting is done when the inspection parameter deviates from the initial value, and adjusting the furnace setting is adjusting the heat input into the area of the furnace, adjusting the heat input into the total area of the furnace, adjusting the heat input in the multiple areas of the furnace or adjusting the heat input in the localized pattern in the furnace.

14. The method according to claim 11 wherein quenching the glass sheet at the quenching station comprises directing air toward the glass sheet, with the quenching station affecting flow or distribution of the air toward the glass sheet, with the inspection parameter having an initial value, and adjusting the quench setting is done when the inspection parameter deviates from the initial value, and adjusting the quench setting is adjusting the flow or the distribution of the air directed toward the glass sheet.

15. The method according to claim 11 wherein measuring the inspection parameter is measuring a depth profile of a glass sheet, measuring an end profile of a glass sheet, measuring a side profile of a glass sheet, or measuring a two-dimensional profile of a glass sheet.

16. The method according to claim 11 wherein measuring the inspection parameter is measuring lens power, with measuring the inspection parameter measuring a maximum lens power, a minimum lens power and/or a statistical value of lens power.
